(19) United States
(12) Patent Application Publication
(10) Pub. No.: US 2002/0001638 A1
(43) Pub. Date: Jan. 3, 2002

(54) Unit for vibrating concrete and similar materials, and concrete product production plant incorporating the said unit

(75) Inventor: Claudio Subacchi, Caorso (IT)

Correspondence Address: YOUNG & THOMPSON, 745 SOUTH 23RD STREET 2ND FLOOR, ARLINGTON, VA, 22202

(73) Assignee: M. C. A. S. r. l. of Piacenza

(21) Appl. No.: 09/892,849

(22) Filed: Jun. 28, 2001

(30) Foreign Application Priority Data
Jul. 3, 2000 (IT) PC 2000A 000024

(51) Int. Cl. B28B 17/02

(52) U.S. Cl. 425/456

(57) ABSTRACT

A unit designed to vibrate concrete products includes elements designed to impart asymmetrical vibrations to a mould, the motion in one direction being much faster than the motion in the opposite direction. The unit includes a pair of motors which drive two cams on each of which rests an idle roller, connected via a linkage to a table on which the mould is positioned. The rotation of the cams causes the table to vibrate, causing it to move upwards with strong acceleration and then descend with a slower and more regular motion. This system produces a type of vibration which allows concrete to be compacted rapidly without becoming detached from or partly exiting from the mould.

This invention relates to a unit designed to vibrate concrete products which includes means designed to impart asymmetrical vibrations to the moulds, the motion in one direction being much faster than the motion in the opposite direction.

In particular, the unit in accordance with the invention includes a pair of motors which drive two cams on each of which rests an idle roller, connected via a linkage to a table on which a mould is positioned. The rotation of the cams causes the table to vibrate, causing it to move upwards with strong acceleration and then descend with a slower and more regular motion. This system produces a type of vibration which allows concrete to be compacted rapidly without becoming detached from or partly exiting from the mould.

The invention falls into the prefabricating equipment sector, and relates in particular to equipment for the manufacture of concrete products. We will now describe, by way of example, the use of this system in one possible embodiment, namely incorporated in machinery designed to manufacture concrete blocks or self-locking concrete flooring; however, this asymmetrical vibration method could also be used with different embodiments in any sector of concrete product manufacture.

The existing machinery used to manufacture these products fills a mould with a concrete mixture which has the consistency of wet soil, and vibrates the mould to facilitate filling.

When this first stage has been completed the product is calibrated; a presser descends and compresses the concrete together with the vibration, to increase the compacting of the filling material. When this calibration stage has been completed, the products in the mould are immediately ejected onto the corresponding support table, which is removed to allow insertion of a new table under the mould, so that the operating cycle can be repeated.

The vibrations described above can be produced by two techniques.

The inertia technique uses a vibrating table which generates vertical oscillation of the vibrating table by means of suitable cams which are made to rotate, and maintained in phase with one another.

Almost at the end of the vertical stroke of each oscillation thus generated, the vibrating table collides with a wooden or steel table (the product support).

As the mould is pressed against the said table by suitable elastic elements, the mould and the table undergo vertical acceleration due to the blow imparted by the vibrating table, thus compacting the material in the mould.

The second type of equipment involves mechanical systems such as cams, which act on the mould by means of connecting rods, imparting a series of rapid alternating movements to the mould so as to compact the concrete.

However, both these known types of equipment involve specific problems as a result of their operating principle. In the case of inertia equipment, the mould receives a series of blows which move it violently upwards, after which it is returned to the starting position by gravity, together with the action of elastic systems which press it against the product support table. This system often causes imperfect compacting of the concrete because the mould is struck by quite a violent blow, but when the movement of the mould is reversed and it drops down, the concrete it contains tends to exit from it, or in any event to destroy part of the compacting effect generated by the blow. In addition, the support table partly absorbs the shock generated by the vibrating table, thus reducing the compacting effect.

In the case of direct mechanical systems, the mould moves with a uniform alternating motion (ie. with the same upward and downward acceleration) by means of a cam and a connecting rod, with the result that the compacting action generated by the mould vibration is fairly limited, because the differential between the accelerations to which the material is subjected is only the gravity acceleration G resulting from its own mass.

During the calibration stage described above, the vertical harmonic oscillation to which the mould alone is subjected (in these machines the table is pressed against the mould by suitable elastic systems, while the crank mechanism described above is directly anchored to the mould) is actually neutral to compacting, which only takes place as a result of the modest shock generated by the elastic systems, which push the table into contact with the mould.

These problems are now solved by the present invention, which relates to a concrete-vibrating unit (and the corresponding plant) that includes means which impart to the mould asymmetrical vibrations able to push it upwards with considerable acceleration and velocity, and then control its return travel so as to obtain a gradual movement.

This invention will now be described in detail, by way of example but not of limitation, by reference to the annexed figures in which:

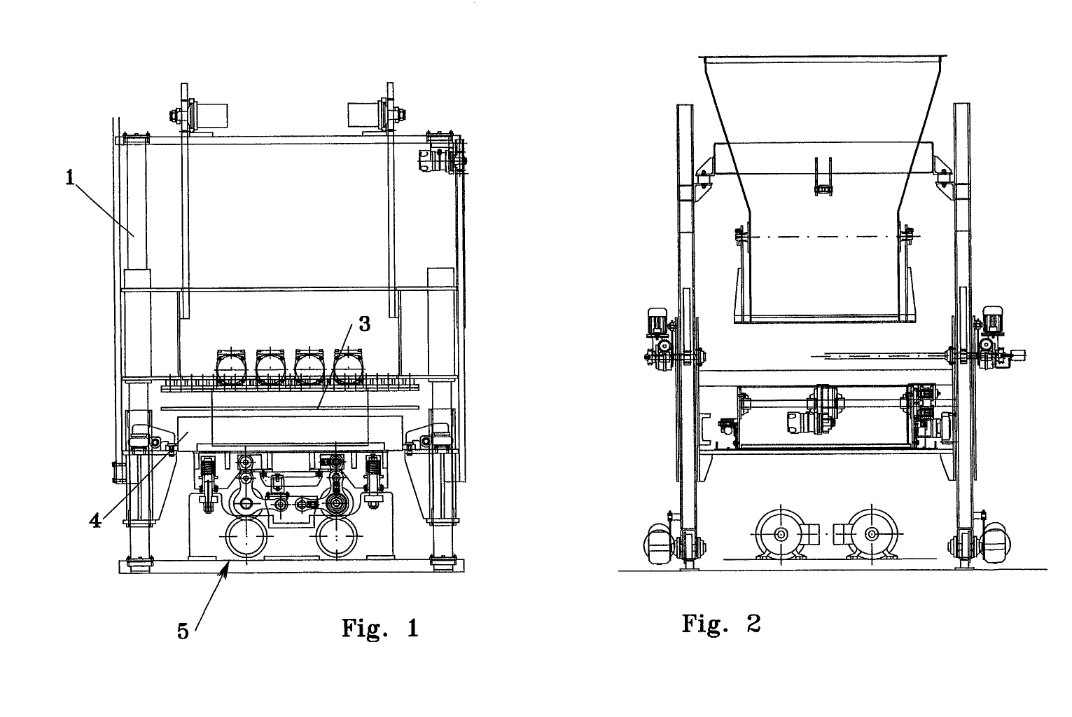

FIG. 1 is a partial elevation of a plant incorporating the concrete-vibrating unit in accordance with the invention

FIG. 2 is another partial elevation of the plant shown in FIG. 1

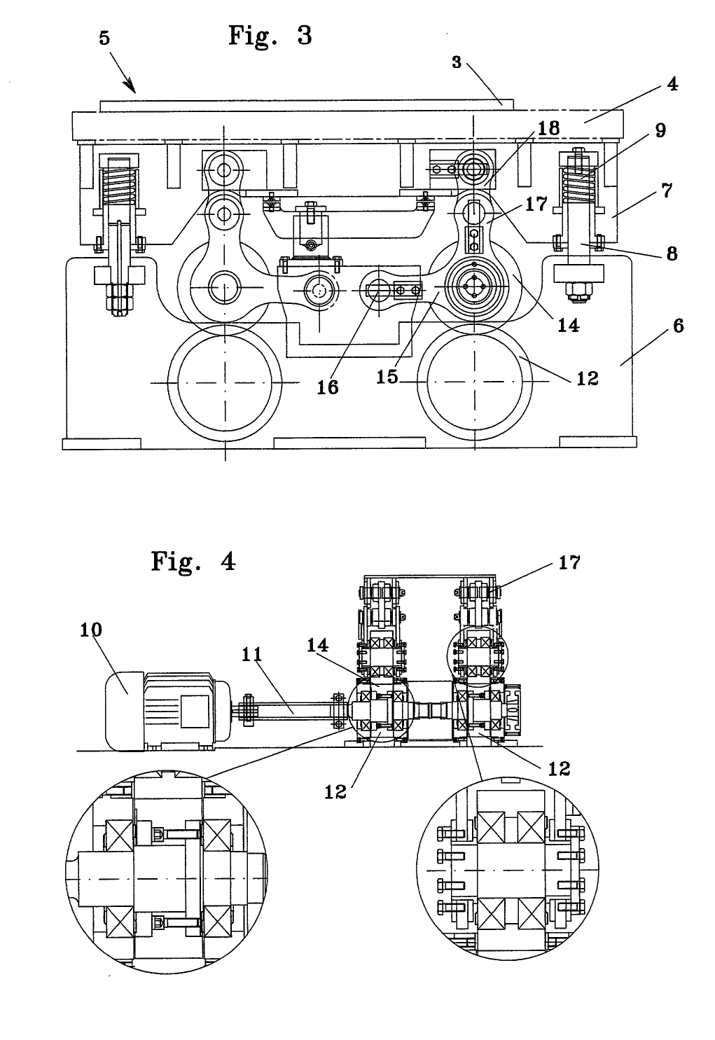

FIG. 3 is a view which illustrates concrete-vibrating unit in accordance with the invention in greater detail

FIG. 4 is a view of the unit orthogonal to the one shown in FIG. 3.

By reference to FIGS. 1 and 2, the plant in accordance with the invention comprises a structure 1 which moves along guide tracks and supports a hopper 2, from which concrete is discharged into a mould or form 3. The latter rests on a table 4, which in turn is mounted on a unit designed to impart vibrations to the mould, indicated as 5 and more particularly illustrated in FIGS. 3 and 4.

Unit 5 comprises a base 6 on which is mounted an impactor 7 that slides along four columns 8, and is subject to the action of a return spring 9.

Table 4, which bears mould 3, is mounted on impactor 7. A pair of electric motors 10 cause two pairs of cams 12, mounted on base 6, to rotate via shafts 1 1. A flywheel is fitted to the shafts on which cams 12 are mounted. An idle roller 14 rests on each of cams 12; the said idle rollers are fitted to a bell crank 15 which is hinged at one end 16 to the base structure, while the opposite end 17 is connected to impactor 7 by means of a connecting rod joint 18. The rotation of cams 12 causes rollers 14 resting on them to rise and fall, thus causing bell crank 15 to rotate around the point at which it is hinged to the base. The bell crank then transmits the motion to the impactor, while connecting rod 18 of the joint compensates for the horizontal movements of the end of arm 17.

The profile of cams 12 is such that rollers 14 are moved upwards very fast, and impactor 7 and mould 3 move with them, while their descent is regulated by the profile of the cam on which roller 14 rests. If the cam profile is suitably varied, a very fast upward movement and a more regular, slower downward movement can obviously be obtained. For example, various tests have demonstrated that good results are obtained by designing the cam profile in such a way that the complete upward movement of rollers 14 is obtained with a cam rotation of approx. 30 degrees, while the return is obtained with a rotation of approx. 330 degrees.

The unit operates as follows.

After the concrete has been poured from hopper 2 into mould 3, the unit can be activated to vibrate the mould and thus compact the concrete. Motors 10 transmit motion to cams 12 and flywheel.

Cams 12 begin to rotate in the opposite direction, pushing rollers 14, which rest on their surface, upwards, and then allowing them to fall.

Rollers 14, fitted to bell cranks 15, pull the said bell cranks with them, causing them to rotate slightly around their hinge points 16.

The movements of cranks 15 are thus transmitted via connecting rod joint 18 to impactor 7 which begins to vibrate, moves rapidly upwards by a few millimeters and then returns to the starting position with a slower, more regular motion, guided by the profile of cams 12. Springs 9 keep the impactor pressed against the movement devices during these movements. The result is a highly effective type of vibration, as the upward movements of the mould take place very fast, so as to compact the concrete effectively and eliminate air bubbles from the mix, while the return travel is far slower and more regular, allowing the concrete to settle and preventing part of the mix from leaking out of the mould during release.

1. A concrete-vibrating unit of the type including means designed to impart vibrations to a mould (3), which includes means (12, 14, 15) designed to impart asymmetrical controlled vibrations to the said mould with a well5 defined acceleration curve and speed.

2. A concrete-vibrating unit as claimed in claim 1, which includes means (12, 14, 15) designed to impart rapid movements to the mould in one direction and slower movements in the opposite direction.

3. A concrete-vibrating unit as claimed in claim 2, wherein said means (12, 14, 15) designed to impart asymmetrical controlled vibrations to the said mould (3) include cam means designed to impart vibrations to the said mould.

4. A concrete-vibrating unit as claimed in claim 2, wherein said means (12, 14, 15) designed to impart asymmetrical controlled vibrations to the said mould (3) include hydraulic slave cylinder, linear motor or electromagnetic means designed to impart vibrations to the said mould.

5. A concrete-vibrating unit as claimed in claim 3, wherein said cam means (12) designed to impart asymmetrical controlled vibrations to the said mould (3) act on a lever (15) hinged to the structure (6) of the machine, from the opposite side the said lever being connected to the mould (3).

6. A concrete-vibrating unit as claimed in claim 5, wherein the said lever means are constituted by bell cranks (15) with one end (16) hinged to the structure (6) and the other end (17) acting on a mould support table (4) in an intermediate position of the said crank, idle rollers (14) being fitted which rest on the said cam (12).

7. A concrete-vibrating unit as claimed claim 6, characterised in that the said bell cranks (15) are connected to an impactor (7) on which the said mould support table (4) is mounted via connecting rod joints (18).

8. A concrete-vibrating unit as claimed in claim 7, wherein the said impactor (7) is mounted in such a way as to slide on a number of columns (8) integral with the machine base (1), spring means (9) being fitted which clamp the said impactor (7) and the said table (4) against the said base.

9. Concrete product production plant characterised in that it includes a concrete-vibrating unit in accordance with one or more of the preceding claims, associated with at least one mould.
